(19) United States
(12) Patent Application Publication
(10) Pub. No.: US 2016/0288579 A1
(43) Pub. Date: Oct. 6, 2016

(54) TREAD WITH IMPROVED DRAINAGE FOR A TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Fabien MARLIER, Clermont-Frerrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/038,180

(22) PCT Filed: Nov. 24, 2014
(86) PCT No.: PCT/EP2014/075438

§ 371 Date: May 20, 2016

(30) Foreign Application Priority Data
Nov. 26, 2013 (FR) 1361617

(51) Int. Cl. B60C 11/03; B60C 11/12

(52) U.S. Cl. CPC B60C 11/0327; B60C 11/1236; B60C 2011/0334

(57) ABSTRACT

Tire tread, this tread having a tread surface intended to come into contact with a roadway and comprising at least one groove of width W and of depth P delimited by two lateral walls facing one another, these two lateral walls being joined together by a groove bottom, at least one groove comprising a plurality of closure devices, each closure device being made up of a flexible blade to close this groove in a rest position to a degree of closure of at least 90%, each flexible blade having a thickness suited to allowing it to deform under the effect of a circulation of liquid in the groove, this at least one flexible groove being secured to the two lateral walls delimiting the groove and to the bottom of the groove, each flexible blade being dimensionally suited to be able, under the action of a flow of liquid, to deform in the groove thereby reducing its degree of closure of the cross section of this groove to at most 40%.

This application is a 371 national phase entry of PCT/EP2014/075438, filed 24 Nov. 2014, which claims the benefit of French Patent Application No. 1361617, filed 26 Nov. 2013, the contents of which are incorporated herein by reference for all purposes.

### BACKGROUND

The invention relates to tire treads and more particularly to the tread patterns of these treads and to tires provided with such treads of which the wet weather standing water drainage performance becomes more lasting, these treads not being penalized in terms of wear rate.

As is blown, the use of tires in wet weather driving conditions requires that the standing water in the contact patch in which the tire makes contact with the roadway be eliminated as quickly as possible in order to ensure contact between the material of which the tread is made and this roadway. Water that is not pushed over the front of the tire flows or is collected in part in the grooves formed in the tread of the tire.

These grooves form a flow network which needs to be lasting, which means to say needs to remain effective throughout the service life of a tire from when it is new to when it is removed.

In the case of tires intended for the steered or load-bearing axles of a heavy goods vehicle, it is commonplace to provide the tread of these tires with circumferential (or alternatively longitudinal) grooves of which the depth is equal to the total thickness of the tread (this total thickness not taking into consideration considering the thickness that may be provided in order to allow partial regrooving). Thus, it is possible to obtain a tread that has standing water drainage performance that is always better than a minimum so-called safe performance, and is so regardless of the level of tread wear.

For tires of the prior art, the total void volume ranges, as a general rule, from 10% to 25% of the total volume of the tread that is intended to be worn away during driving (the total volume corresponding to the volume of material plus the said total void volume). It is found that these tires have a void volume available in the contact patch that is relatively large when the tire is new (available meaning that this volume is potentially able to have standing water present on the roadway pass through it). The volume of voids opening onto the tread surface in the contact patch is evaluated when the tire is subjected to its nominal inflation and static loading conditions as defined by the E.T.R.T.O. standard.

While grooves or, more generally, cavities are essential to drawing away the water in the contact patch, the resulting reduction in tread material may appreciably affect the wearing performance of this tread and accordingly reduce the service life of the tire as a result of an increase in wear rate. Other performance aspects of the tire may also be affected, notably performance in terms of handling, road noise and rolling resistance. It is also found that these grooves which are formed to have a working depth equal to the height of tread available to wear away may be the cause of endurance problems. Under certain driving conditions, foreign bodies such as stones may become lodged in these grooves and attack the bottom of these grooves causing breaks to appear in the rubber.

Creating a plurality of grooves on a tread therefore has the disadvantage of reducing the quantity of tread material for a given width of tread and consequently of reducing the service life of the tire as a result of an excessively high wear rate.

Moreover, the grooves lead to a reduction in the compression and shear rigidity because these grooves delimit portions of material which are more sensitive to deformation as compared with the portions delimited by sipes. Specifically, in the ease of sipes, the walls of material delimiting these sipes can come into contact with one another at least when that portion of the tread becomes the contact patch. This reduction in rigidity, in the case of the presence of grooves, leads to an increase in deformation and generates a reduction in tread wear performance: greater wear is found for a set distance covered (this corresponds to an increase in the tread wear rate). Furthermore, an increase in rolling resistance and therefore fuel consumption is observed with vehicles equipped with such tires, as a result of an increase in hysteresis losses associated with the deformation cycles of the material of which the tread is made.

The applicant companies have found that the crossings of grooves was the cause of a reduction in driving performance on a road surface covered with a deep film of standing water. This is because these crossings cause disruptions to the flows along each groove.

In order to limit the reduction in rigidity associated with the presence of the grooves which is required by the need to drain the water away, a solution described in patent publication WO 2011/039194 has been proposed. This solution proposes a tire tread of thickness E, this tread being provided with a plurality of wavy grooves with waviness in the thickness. Each wavy groove is continuous so as to allow a flow of fluid and is formed in the tread by a plurality of external cavities opening onto the tread surface when the tread is new and a plurality of internal cavities, the latter being positioned radially and completely within the tread surface when the tread is new. The internal cavities may be intended to lie at different depths.

Furthermore, the continuity of the wavy groove is assured by the presence of connecting cavities connecting the external cavities to the internal cavities. Each connecting duct has two ends connected to an internal cavity on the one hand and to an external cavity on the other; each connecting duct has cross sections (in a plane of section perpendicular to the mean direction of the groove) of which the areas are equal respectively to the cross-sectional areas of the internal and external cavities that are connected by this connecting duct.

Thanks to the presence of these connecting cavities, it is possible to allow water to circulate from an external cavity towards an internal cavity, thereby achieving better drainage of the water while at the same time reducing hydrodynamic losses in pressure head.

In addition, by virtue of this tread structure, there is obtained a void volume that is suited to achieving satisfactory drainage while at the same time limiting the reduction in rigidity of the tread when the tread is new.

In the present document, the terminology “wavy cavity” with waviness in the thickness of a tread refers to any continuous cavity having a wavy geometry with waviness in the thickness of the tread and such that it can open discontinuously onto the tread surface of the tread either when the tread is new or once it is part worn. This wavy cavity, as soon as it is open at least in part onto a tread surface via external cavities, forms a groove allowing liquid to circulate, the external cavities being connected to one another by internal cavities. A wavy cavity may extend over more than two successive levels within the thickness of the tread.

That same document describes a tread comprising a first plurality of wavy grooves with waviness between a first wear layer and a second wear layer in a first direction and a second plurality of wavy grooves with waviness in the same wear layers and directed in a second direction that crosses the first direction to form a network of crossed grooves. These first and second pluralities of grooves are arranged in such a way that the internal cavities of these first and second pluralities of grooves are connected to one another in order to reinforce the network effect.

The problem described in respect of treads having only non-wavy grooves has also been observed with this last type of tread.

Definitions:

Equatorial midplane: this is a plane perpendicular to the axis of rotation and passing through the points of the tire that are radially furthest from the said axis.

A block is a raised element formed on the tread and delimited by voids or grooves and comprising lateral walls and a contact face intended to come into contact with the roadway. This contact face has a geometric center defined as being the barycenter or center of gravity of the face.

A rib is a raised element formed on a tread, this element extending in the circumferential direction and making a full circuit of the tire. A rib comprises two lateral walls and a contact face, the latter being intended to come into contact with the roadway during driving.

A radial direction in this document means a direction perpendicular to the axis of rotation of the tire (this direction corresponds to the direction of the thickness of the tread).

A transverse or axial direction means a direction parallel to the axis of rotation of the tire.

A circumferential direction means a direction tangential to any circle centered on the axis of rotation. This direction is perpendicular both to the axial direction and to a radial direction.

The total thickness E of a tread is measured, in the equatorial plane of the tire provided with this tread, between the tread surface and the radially outermost part of the crown reinforcement when the tire is new.

A tread has a maximum thickness PMU of material that can be worn away during running, this maximum thickness PMU being less than the total thickness E.

The usual running conditions of the tire or service conditions are those defined by the E.T.R.T.O. standard in the case of European conditions; these conditions of use specify the reference inflation pressure corresponding to the load bearing capacity of the tire as indicated by its load rating and speed code. These conditions of use may also be referred to as “nominal conditions” or “service conditions”.

A cut generically refers either to a groove or to a sipe and corresponds to the space delimited by walls of material facing one another and distant from one another by a non-zero distance (referred to as the “width of the cut”). What differentiates a sipe from a groove is, precisely, this distance; in the case of a sipe, this distance is suited to allowing the opposing walls delimiting said sipe to come into at least partial contact at least when they enter the contact patch in which the tire is in contact with the roadway. In the case of a groove, the walls of this groove cannot come into contact with one another under normal running conditions.

In this document a cavity denotes a groove or a duct intended to form a new groove following part wear. The same term can be used to denote a combination of parts open onto a tread surface and of underlying parts lying beneath the tread surface, these underlying parts joining together the parts that are open onto a tread surface so as to form what is referred to as a wavy cavity with waviness in the thickness of the tread.

### SUMMARY

The present disclosure seeks to maintain good wet weather driving performance by proposing an improved tread pattern design.

To this end, the subject of the disclosure is a tire tread comprising a tread surface intended to come into contact with a roadway, this tread having a total thickness E and comprising a plurality of cavities, at least a first cavity being oriented in a first direction and at least a second cavity being oriented in a second direction different from the first direction. These first and second cavities open onto the same tread surface, it being possible for this tread surface to correspond either to the tread surface when the tread is new or to the tread surface obtained when the tread is part worn.

Furthermore, the first cavity crosses the second cavity, which means to say that there is a region of crossing in which both cavities are present.

This tread is characterized in that, in the region of crossing of the first cavity with the second cavity, one of these two cavities passes radially underneath the other cavity, there being retained, in this region of crossing, a non-zero minimum distance between the first cavity and the second cavity so that the flow circulating along one of these cavities does not disturb the flow that may be circulating in the other cavity.

Advantageously, the tread is such that at least the cavity oriented in the first direction is a wavy cavity with waviness in the thickness of the tread, which means to say formed of a succession of cavity portions which are intended to open onto the tread surface either when the tread is new or when it is part worn, and of cavity portions located within the tread.

For ease of manufacture it is preferable that, in the case of there being at least one wavy cavity with waviness in a first direction, a ripe extends as far as the tread surface when the tread is new those cavity portions that are located within the tread. In the region of crossing, this ripe intersects the other cavity oriented in the second direction.

In the case of a tread intended to be fitted to a tire for a heavy goods vehicle, the reduction in tread thickness may lead to difficulties in passing one cavity radially underneath another without disturbing the flow. It is then sensible to modify the cross section of the cavity in the part thereof that passes radially underneath another cavity. In that case it is advantageous for the cross section of the cavity portion that passes radially underneath another cavity in a region of crossing to be kept constant or at the very least equal to the cross section of the cavity outside of the region of crossing. This can be achieved by a suitable widening of the cross section.

Further features and advantages of the disclosure will become apparent from the description given hereinafter with reference to the attached drawings which, by way of nonlimiting examples, depict embodiments of the subject matter of the disclosure.

### BRIEF DESCRIPTION OF THE FIGURES

FIG. 1 is a view in cross section of a first alternative form of tread according to the an embodiment;

FIG. 2 is a plan view of the alternative form shown in FIG. 1;

FIG. 3 depicts an alternative form of crossing;

FIG. 4 is a plan view of another alternative form of crossing;

FIG. 5 is another alternative embodiment, showing a crossing of two wavy cavities entirely contained within the tread.

### DESCRIPTION OF THE FIGURES

To make the figures easier to understand, identical reference signs have been used for describing alternative forms of the disclosure where these reference signs refer to elements of the same kind, be it structurally or functionally.

FIG. 1 depicts a partial view of a first alternative form of tread 10 for a heavy goods vehicle tire according to the disclosure. In this alternative form, a first groove 1 opens in its entirety onto the tread surface 100 of the tread 10 when the tread is new. This first groove 1 extends in a first direction denoted XX′.

A second groove 2 is oriented in a second direction perpendicular to the first direction XX′; this second groove 2 crosses the first groove 1 in a region of crossing 3. In this region of crossing 3, the second groove 2 dips down locally into the thickness of the tread to pass radially on the inside of the first groove 1, leaving a space of material with a non-zero minimum thickness D between the first and second grooves. In the region of crossing, the groove 2 comprises two oblique parts 20 connected by a straight part 200.

In this way, it is possible to ensure the continuity of the flow be it in the first groove 1 or the second groove 2, without generating disturbance between the flows.

The minimum thickness D is at least equal to 0.1 mm. More preferably still, this minimum thickness D is at least equal to 1 mm.

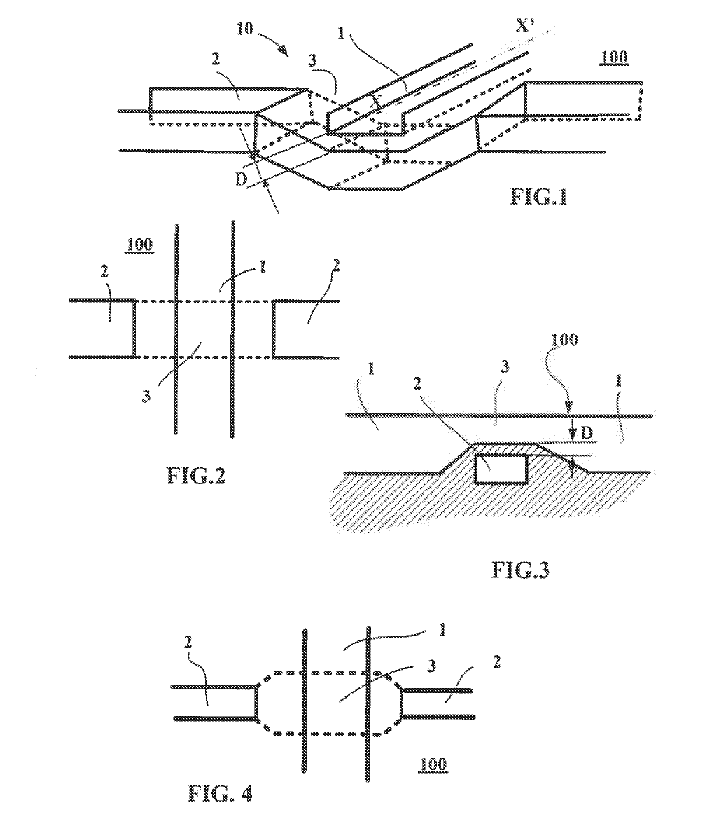

FIG. 2 shows a plan view of the alternative form depicted in FIG. 1. It is possible in this FIG. 2 to make out the groove 1 that opens over its entire length onto the tread surface 10 when the tread is new. This groove 1 has an identical depth over its entire length and a constant width. The second groove 2 has a cross section which is constant whatever the position considered, notably the cross section is maintained in the region of crossing 3.

In the alternative form depicted in FIG. 3, there is the same type of crossing of two grooves 1 and 2 as that shown in FIGS. 1 and 2. However, the first groove 1 has a reduced depth in the region of crossing 3 so as to leave space for the second groove 2 to pass radially on the inside, leaving a distance of material of height D. This alternative form is particularly advantageous when the dimensions of the first groove 1 do not allow the second groove 2 to be passed radially on the inside of it or alternatively would require a very appreciable reduction in the cross section of this second groove in this region of crossing.

In the alternative form of FIG. 4, the second groove 2 is modified in order to maintain the total cross sectional area in its part that passes radially on the inside of the first groove 1. To achieve that, the cross section of the groove 2 is reduced in height and increased in width in the region of crossing 3. Thus it is possible to allow two grooves to cross while at the same time maintaining a good ability for a given volume of liquid to flow during running.

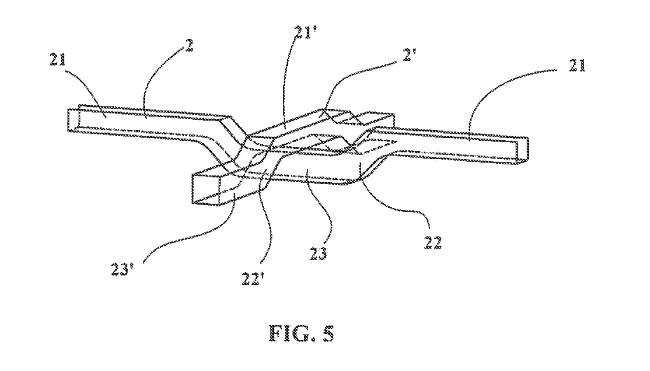

The alternative form depicted in FIG. 5 relates to the use in a tread of two wavy grooves 2 and 2′ each one when the tread is new forming a continuous groove that exhibits waviness in the thickness of the tread between a tread surface intended to come into contact with a roadway and a depth at most equal to the thickness of material that can be worn away during driving.

Each of these wavy grooves 2 and 2′ opens when the tread is new at various points on the tread surface of a tread that is new. The openings form cavities 21, 21′ not connected to one another.

Moreover, each wavy groove is continuous thanks to the presence of cavity parts 22, 22′ respectively which connect the cavities open on the tread surface when the tread is new with the cavities 23, 23′ formed within the tread.

The first wavy groove 51 is oriented in a first direction while the second wavy cavity 52 is oriented in a second direction that crosses the first direction. These two wavy grooves 51 and 52 are arranged in such a way that in the region of crossing 53, the first of these wavy grooves 51 comprises a part open onto the tread surface while the second wavy groove passes radially on the inside of the first groove. The minimum thickness between the two wavy cavities is at least equal to 0.1 mm but of course could be significantly greater, such as 1 mm or more for example.

Thus, when the tread is new, when driving on a roadway covered with standing water, for example in the rain, the continuity of the wavy grooves ensures good flow of water in each groove and use of the disclosure prevents each flow of liquid in one groove from interfering with the flow in the other groove.

FIG. 5 depicts only wavy grooves. In order to make such grooves easier to mold, it is preferable for those parts of the grooves that pass along inside the tread in the region of crossing to be extended by sipes that have no appreciable effect on the flow in each groove. These sipes connect the parts under the surface of the tread to said tread surface.

FIG. 5 shows only the crossing of two wavy grooves, but the creation of a wavy groove comprising a plurality of regions of crossing with a plurality of grooves crossing this wavy groove can be easily contemplated.

The disclosure also relates to a tire provided with a tread as described.

Of course, the disclosure is not restricted to the examples described and depicted and various modifications can be made thereto without departing from the scope as defined by the claims. Notably, that which has been described in relation to a first groove and a second groove could easily be contemplated with more than two grooves crossing in one and the same region of crossing.

1. A tread for a tire, comprising:
a tread surface that contacts with a roadway, the tread having a total thickness and including a plurality of cavities,
with at least a cavity being oriented in a first direction and at least a second cavity being oriented in a second direction different from the first direction, the first and second cavities opening when the tread is new or part worn onto the same tread surface,
the first cavity crossing the second cavity in a region of crossing,
wherein, in the region of crossing of the first cavity and the second cavity, one of the first or second cavities passes radially underneath the other cavity,
in the region of crossing, a non-zero minimum distance D between is formed between the first and second cavities, so that a flow circulating along one of the first or second cavities does not disturb the flow circulating along the other cavity.

2. The tread according to claim 1, wherein at least the first or second cavity oriented in the first direction is a wavy cavity with waviness being formed in a thickness direction of the tread, with the waviness being formed so that a succession of cavity portions open onto a tread surface either when the tread is new or when it is part worn, and of cavity portions located within the tread.

3. The tread according to claim 2, wherein a sipe extends to the tread surface when the tread is new, with cavity portions that are located within the tread.

4. The tread according to claim 1, wherein each cavity having a cross section, the cross section of the cavity portion that passes radially underneath another cavity in a region of crossing is at least equal to the cross section of the cavity outside of the region of crossing, thereby allowing the flow in the groove that passes underneath the other.

5. A tire for a heavy goods vehicle, comprising:
a tread surface that contacts with a roadway, the tread having a total thickness and including a plurality of cavities,
with at least a first cavity being oriented in a first direction and at least a second cavity being oriented in a second direction different from the first direction, the first and second cavities opening when the tread is new or part worn onto the same tread surface, the first cavity crossing the second cavity in a region of crossing,
wherein, in the region of crossing of the first cavity and the second cavity, one of the first or second cavities passes radially underneath the other cavity,
in the region of crossing, a non-zero minimum distance D between is formed between the first and second cavities, so that a flow circulating along one of the first or second cavities does not disturb the flow circulating along the other cavity.

6. The tire according to claim 5, wherein at least the first or second cavity oriented in the first direction is a wavy cavity with waviness formed in a thickness direction of the tread, with the waviness being formed so that a succession of cavity portions open onto a tread surface either when the tread is new or when it is part worn, and of cavity portions located within the tread.

7. The tire according to claim 6, wherein a site extends to the tread surface when the tread is new with cavity portions that are located within the tread.

8. The tire according to claim 5, wherein each cavity having a cross section, the cross section of the cavity portion that passes radially underneath another cavity in a region of crossing is at least equal to the cross section of the cavity outside of the region crossing, thereby allowing the flow in the groove that passes underneath the other.
